(19) United States
(12) Patent Application Publication
(10) Pub. No.: US 2007/0220417 A1
(43) Pub. Date: Sep. 20, 2007

(54) System and method for editing online documents

(75) Inventors: Boban Mathew, Arlington, VA (US); Thomas John, Austin, TX (US); Dagny Evans, Alexandria, VA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Sonolink Communications Systems, LLC

(21) Appl. No.: 11/378,043

(22) Filed: Mar. 17, 2006

(51) Int. Cl. G06F 15/00

(52) U.S. Cl. 715/511

(57) ABSTRACT

A system and method for editing documents available over a Web session. For example, one embodiment of the method comprises: establishing a Web session with a user computer; receiving a user request to edit a document from the user computer, the document having a particular document type and stored on a remote computer; automatically downloading a copy of the document and one or more modules to the user computer, the one or more modules to perform the operations of: invoking an application associated with the document type on the user computer, the application to provide an interface allowing the user to edit the document on the user computer; monitoring the state of the document copy, the state including an indication as to whether the document copy has been modified by the user to create a modified document copy; automatically uploading the modified document copy to the remote computer responsive from an indication that the document copy has been modified.

### BACKGROUND

1. Field of the Invention

This invention relates generally to the field of document management systems. More particularly, the invention relates to a system and method for editing and automatically updating documents on a server over a network connection.

2. Description of the Related Art

Computer users work with various types of documents. By way of example, an individual user may work with written documents processed using a word processing program such as Microsoft Word® or Corel WordPerfect®; spreadsheets created and edited through programs such as Microsoft Excel® and Lotus 1-2-3®; and text files that are edited using text editors such as Vi or Notepad. Moreover, users in different professional fields typically work with different document types. For example, many graphical professionals work with Adobe Photoshop® files while many engineering professionals work with AutoDesk® drawings.

Typically, documents edited by a user are stored on the user's own personal computer or workstation. Programs used to edit such documents are also typically installed on the user's own computer. A user may identify documents in terms of type, size and date of access and select documents via a windowed user interface provided by operating systems such as Microsoft Windows or Apple Macintosh OS. The user may then invoke the program that processes the selected document through an interaction defined by the operating system. For example, in a Microsoft Windows operating system, the user generally “double clicks” on an icon representing the document, thereby invoking the program used for processing information stored in the document. The user may then work with the document and edit its contents. After editing, the user may save the document so that the modified document now resides on the user's computer in place of the original document.

In some cases, the user can interact with, i.e., edit, a document stored on a computer other than the user's own computer. For example, if the operating system of the user's computer allows it, the user may edit a document that is stored on the hard disk of another computer that is made to appear to be a hard disk on the user's own computer. In this case, the user is interacting with a document that is on a “shared disk” that is made to appear to be a disk that is physically inside the user's own computer. In these cases also, the user may directly access the document, edit its contents, and save the modified document back to the original computer that was made to appear as a hard disk on the user's own computer. This shared disk approach is common in the context of local area networks within an organization.

Shared disks such as those described above, however, are generally not made available over public networks such as the Internet due to security risks from other computers that may try to access the shared disk. Thus, although users may generally access, open and read documents available on the World Wide Web, changes made to the documents will not be registered at the location where the document is stored (e.g., a Web server or other type of remote server). In order to modify the document access over the public Internet and return the modified document over the public Internet back to the original location, a user must download the document or otherwise make a copy of the document on his/her computer, make changes, and then manually save the changes back to the original location, often by uploading the modified document.

Another possible way to edit documents on a remote computer is to open a remote network connection through a mechanism such as a socket. This method is used, for example, in X-windows, where a document may be edited by giving the user's display, keyboard and mouse control over actions on a remote computer. In this method, screen shots and the above described actions (keystrokes and mouse clicks) are exchanged between the remote computer and the user computer. This is the approach of solutions generally classified as “remote desktop” solutions. Furthermore, all applications required to open and edit documents must be installed on the remote computer, thereby increasing the performance demands on the remote computer and decreasing the performance experience of the user.

Thus, what is needed is a system which enables users to edit documents stored on computers that are accessible over the World Wide Web or over a local network via an Internet browser application as though they were editing the document on their local computer, thereby ensuring equivalent document editing performance, and without requiring the user to manually download the original version of the document and then upload the edited version of the document.

### SUMMARY

A system and method for editing documents available over a Web session. For example, one embodiment of the method comprises: establishing a Web session with a user computer; receiving a user request to edit a document from the user computer, the document having a particular document type and stored on a remote computer; automatically downloading a copy of the document and one or more modules to the user computer, the one or more modules to perform the operations of: invoking an application associated with the document type on the user computer, the application to provide an interface allowing the user to edit the document on the user computer; monitoring the state of the document copy, the state including an indication as to whether the document copy has been modified by the user to create a modified document copy; automatically uploading the modified document copy to the remote computer responsive from an indication that the document copy has been modified.

### BRIEF DESCRIPTION OF THE DRAWINGS

A better understanding of the present invention can be obtained from the following detailed description in conjunction with the following drawings, in which:

FIG. 1 illustrates a system for editing documents online according to one embodiment of the invention.

FIG. 2 illustrates a method for editing documents online according to one embodiment of the invention.

FIG. 3 illustrates a system for automatically authenticating and installing an application on a user computer according to one embodiment of the invention.

### DETAILED DESCRIPTION OF PREFERRED EMBODIMENTS

Described below is a system and method for editing documents over a Web session. In such a system, users may (1) access documents over an Internet browser application; (2) edit the documents locally on the user's computer as though the document were resident on the user computer; and (3) save the modified document back to the original location without manual intervention. One embodiment of the invention allows an end user to edit documents stored on computers that are accessible over the World Wide Web (“the Web”) or more generally over an Internet browser session. In addition, once the user finishes editing the document, one embodiment of the invention allows the changes to beautomatically saved to the original storage location of the document on the Web. Moreover, one embodiment of the invention operates without the need for the user to install additional application software and provides the same behavior as if the document being edited were stored locally on the user's computer.

Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Note that in this detailed description, references to “one embodiment” or “an embodiment” mean that the feature being referred to is included in at least one embodiment of the invention. Moreover, separate references to “one embodiment” in this description do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

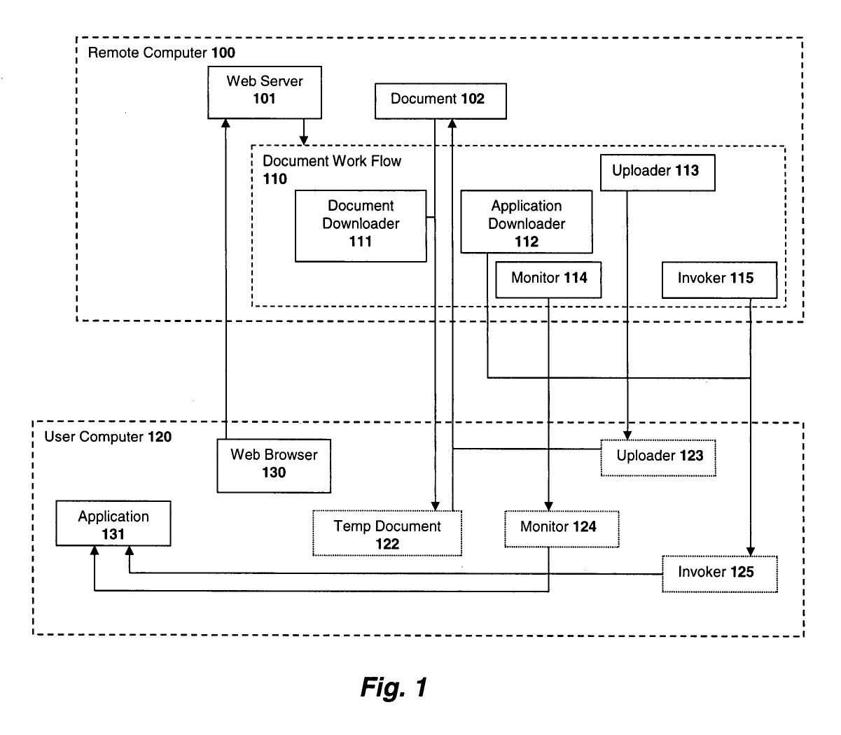

FIG. 1 illustrates a system architecture according to one embodiment of the invention which includes a “remote” computer 100 and one or more user computers 120 which establish Web sessions with the remote computer 100 over the Internet (or other network). In one embodiment, the user computer is a Windows-based personal computer with an installed Web browser 130 (e.g., Microsoft Internet Explorer®, Firefox®, etc). The remote computer 100 hardware can be any hardware capable of storing documents and running the program components described herein which may be created in programming languages such as C, Java and Basic. The remote computer includes a Web server 101 that may be any Web server capable of connecting to and initializing the document workflow program 110 (as described below). One example of an adequate hardware and software is a Linux computer with Apache Tomcat web server. Another example is a Windows NT computer with Microsoft's Internet server.

The user's computer 120 and remote computer 100 may communicate over the network using various different network protocols. For example, in one embodiment, user computer and remote computer communicate using the transmission control protocol-internet protocol (“TCP/IP”) at the transport and network layers, respectively (i.e., under the Open System Interconnection (“OSI”) model). In addition, in a Web-based environment, the user computer and remote computer communicate using the hypertext transport protocol (“HTTP”) and the file transfer protocol (“FTP”) at the application layer. Of course, the underlying principles of the invention are not limited to any particular set of network protocols.

As illustrated in FIG. 1, one or more applications 131 are installed on the user's computer 120 to enable to user to open and edit documents of various types. For example, the Microsoft Word may be installed for editing word processing documents, Adobe Photoshop may be installed for editing photos and Microsoft Excel may be installed for editing spreadsheets. A virtually unlimited number of additional applications may be installed on the user's computer 120 and used within the context of the present invention. Moreover, given that current operating systems such as Windows XP® allow users to simultaneously edit multiple documents, there may be multiple applications 131 active at a time to concurrently edit multiple documents (although only one is shown for clarity).

As illustrated in FIG. 1, the remote computer 100 (or group of computers) includes a Web server 101 for communicating with the user computer via the Web browser 130 (e.g., using Internet protocols such as HTTP). For example, the Web server may receive HTTP requests from the Web browser 130 and generate responses.

In one embodiment, a document workflow module 110 is initialized by the Web server 101 in response to user requests to edit documents 102 sent from the user computer 120. As shown in FIG. 1, the document workflow module 110 employs a variety of modules for implementing the embodiments of the invention described herein. In particular, the instance of the document workflow module 110 shown in FIG. 1 includes/initializes a document downloader module 111, an application downloader module 112, a monitor module 114, an uploader module 113 and an invoker module 115, each of which will be described in greater detail below.

One embodiment of the invention automates various different operations associated with editing a document stored on a remote computer and automatically storing the results back to the remote computer. Specifically, when a user at the computer 120 attempts to edit or otherwise work with a document stored on the remote computer, a temporary set of monitoring and file transfer programs 123, 124, and 125 are transferred to the user's computer under the control of the application downloader module 112. The temporary set of monitoring and file transfer programs 123, 124, and 125 are temporary versions of the uploader module 113, monitor module 114 and invoker module 115, respectively.

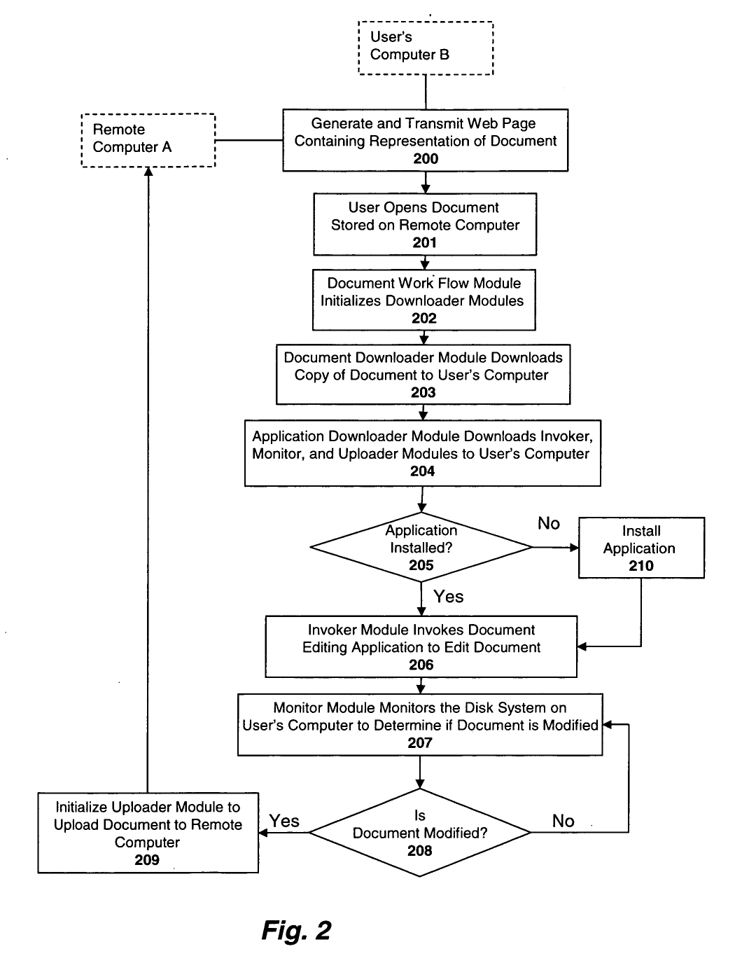

FIG. 2 illustrates one embodiment of method for online document editing which will be described within the context of the architecture shown in FIG. 1. It should be noted, however, certain specific details illustrated in FIG. 1 are not required for complying with the underlying principles of the invention.

At 200, the remote computer generates a Web page containing a representation of the document 102 (e.g., an icon embedded within the Web page) and transmits the Web page to the remote computer browser 130 using standard Web-based protocols (e.g., HTTP). The user is thereby able to view the representation of the document via the Web browser.

At 201, the end user opens the document 102 (which is still stored on the remote computer 100). Various techniques may be used to open the document. For example, in one embodiment, the user selects the onscreen representation of the document via a keyboard, mouse or other cursor control device (e.g., by “clicking on” the icon representing the document from within the Web page).

At 202, the document workflow module 202 (which may have been previously initialized by the Web server) initializes downloader modules 111 and 112 to coordinate the transfer of copies of the document 122 and the various other modules 123-125 to the user's computer 120.

At 203, the document downloader module 111 downloads a copy of the document 122 to the user's computer 120. In one embodiment, this involves identifying a predefined location where the temporary document may be stored and edited on the remote computer 120 (e.g., a “temporary document” directory within the file system of the remote computer 120) and implementing a file transfer operation (e.g., using FTP or other protocol).

At 204, the application downloader module downloads copies of the uploader module 123, the monitor module 124 and the invoker module 125 to the user's computer 120. Although illustrated as three separate software modules 123-125 in FIG. 1, in one embodiment, the modules are combined into a single program that has the three separate capabilities 123-125.

At 204, the invoker module 125 (or other software module) determines whether the application required to edit the document is installed on the user's computer 120. For example, the invoker module may identify the document type based on the extension associated with the document (e.g., .PDF for Adobe Acrobat files, and .DOC for Microsoft Word documents) and then query the operating system to determine if the appropriate application is installed.

If the application is already installed, then at 206, after the copy of the invoker module 125 and the copy of the document 122 are fully downloaded, the invoker module invokes the application 131 associated with the document on the user's computer 120, thereby allowing the user to edit the document. In one embodiment, the invoker module 125 accomplishes this by identifying the application 131 based on the document type and calling the executable file for the application. The invoker module 125 may invoke multiple applications simultaneously if the user chooses to edit multiple documents simultaneously.

At 207, once the application 131 is initialized with the copy of the document 122, the monitor module 124 monitors whether the user has modified the document and stores the results back on the hard disk of the remote computer 100 (e.g., using the “save” or “save as” functions within the document editing application 131). Various techniques may be used to determine whether the document has been modified including, for example, comparing the “last modified” date/time of the copy against the “last modified” date/time of the original document; comparing a version number of the copy against the version number of the original, comparing the underlying data within the copy against the underlying data within the original, etc. Various other known methods for comparing documents may be employed while still complying with the underlying principles of the invention.

In a multiple-document implementation, the monitor module 124 monitors the status of multiple documents that are open on user's computer 120. In one embodiment, the monitor module 124 continues to check the status of the documents it monitors at predetermined time intervals (e.g., a few seconds, a few minutes, etc). In another embodiment, rather than periodically checking the status of the document, the monitor module 124 actively receives an indication each time the document is modified (e.g., by listening for the “save” command executed by the application).

In one embodiment, for each document, the monitor module 124 locally implements the same document management policy employed on the remote server. For example, the policy may indicate that certain documents may be modified but may not be deleted. Similarly, certain documents may be modified but a copy of the original document must be retained (i.e., as in a document versioning system). Implementing these policies locally at the user's computer 120 rather than at the remote computer 100 reduces network traffic between the user's computer and the remote computer 100.

The monitor module 124 may implement any type of policy control. To enable the monitor module to be installed in the browser environment or any other limited access environment, the module 124 is wrapped as a downloadable and executable module permitted by the browser or similar environment. In one embodiment, the monitor module 124 may be wrapped as an ActiveX component. In another embodiment, the monitor module may be wrapped as a Java-based applet.

Inside the wrapping of ActiveX or Java applet, the monitor module 124 implements access to processes running on the Web server. In one embodiment, the monitor module communicates with the Web server using private format commands that may be in a text-based format or a binary format. The protocol used by the monitor module 124 to interact with the server is based on a command-response format similar to those used in autonomous agent communication protocols.

Standardized agent communication protocols, such as Knowledge Query Manipulation Language (KQML), may be used for communications between the monitoring module and the server. In a preferred embodiment, privately defined communication protocols may be defined over the underlying Internet communication protocol of TCP/IP. In a privately defined communication protocol, the server and monitoring module may exchange messages intended to establish the security of the exchange by using a sequence of actions that are context-dependant. Thus the appropriate responses to commands are known only on the server. Furthermore, the actions performed on the server as a result of exchanges with the monitor module are only those actions that are safe and permissible within the server environment. One such sequence of commands informs the server about the status of a document that was recently downloaded from the server to the user's computer for editing, as described in greater detail below.

The foregoing details associated with the monitor module 124 and the techniques of communicating with the remote server may also be employed for the other modules described herein (e.g., the uploader module 123 and the invoker module 125).

At 208 a determination is made as to whether the document has been modified by the user. If the version on the user's computer is not changed, then the process loops back to 206 and the monitor module 124 continues to check for changes to the copy of the document 122. If the version on the user's computer is changed, then the monitor module 124 initializes the uploader module 123 to transmit a copy of the changed document back to the remote computer 100, which automatically stores a copy in place of the original document 102. In one embodiment, if the connection between the user's computer 120 and remote computer 100 is temporarily lost (e.g., due to network problems), the uploader module 123 will continuously and/or periodically reattempt to upload the latest version (or versions if a versioning system is used) of the document. Thus, as distinguished from prior systems, the user may continue to edit the document and save changes even though the network connection is temporarily inoperative. When the connection is subsequently reestablished, the uploader module 123 will automatically upload the latest version (or versions) of the document to the remote computer 100.

In one embodiment, rather than simply replacing the document, the remote computer 100 employs a versioning module (not shown) to store and manage multiple versions of the document as the document is edited thereby allowing the user (or other users) to “roll back” to an earlier version, if necessary.

In one embodiment, the user computer 120 and all of the additional modules 123-125 executed on the user's computer communicate with the remote server 100 using the network and security protocols required to maintain a Web session with the remote computer 100. For example, the uploader module 123 may use various types of authentication and/or encryption techniques when uploading the modified document to the remote computer 100 (e.g., SSL techniques). Accordingly, updating of the document 102 on the remote computer occurs transparently to the end user. That is, from the user's point of view, document modification occurs just as if the document were stored locally, rather than on a remote computer through a Web session.

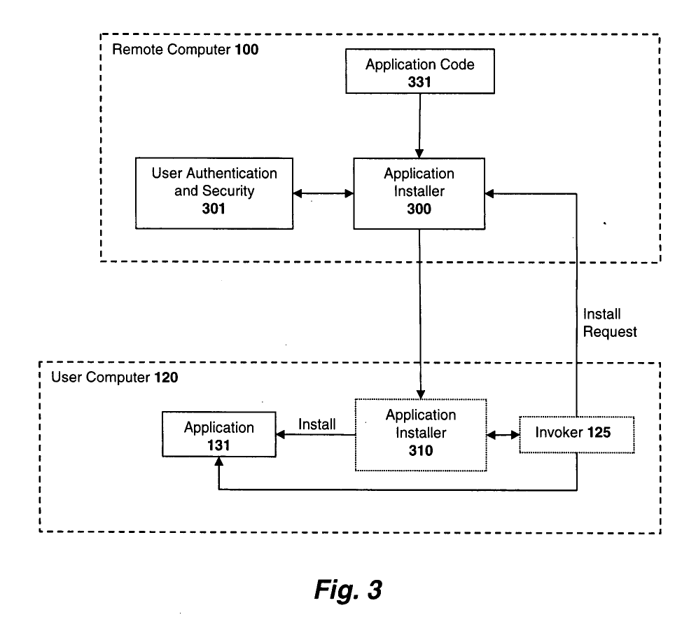

Returning to 205, if the application required to edit the document is not installed, then at 210, the invoker module 125 attempts to install the application from the remote computer 100. FIG. 3 illustrates one embodiment of an architecture for installing the application. In this embodiment, the invoker module 125 transmits an installation request to an application installer module 300 on the remote computer 100. In one embodiment, the application installer module 300 communicates with a user authentication and security module 301 to determine whether the user has the right to install the application (e.g., whether the user or the user's company has a license to use the application). To make this determination, the user authentication and security module 301 may first require user/computer authentication data (e.g., a user name and password, a computer ID code, etc) and then compare the user/computer against a list of users/computers that are licensed to install/use the application 131. Various other techniques for user authentication and security may be employed while still complying with the underlying principles of the invention.

The user authentication and security module 301 notifies the application installer 300 as to whether the user has the right to install the application. If not, then the application installer module 300 denies the installation request. If so, then in one embodiment, a local application installer module 310 is transmitted to the user's computer along with the application program code 331 required to install the application. After the application 131 is successfully installed, the process returns to 206 and the invoker module invokes the application 131.

The various modules and applications described above may represent various different types of object code and may be programmed using a variety of programming languages. For example, these modules may be implemented using technologies such as ActiveX® components (from Microsoft) or Java® Applets (from Sun Microsystems) and may be programmed using various different programming languages including, for example, C, C++, C#, Java, JavaScript, Visual Basic and VB Script. Moreover, various different well known architectures may be employed to implement the architecture on the remote computer 100 including, for example, a Java 2 Enterprise Edition (“J2EE”) architecture or a Microsoft .NET architecture. In sum, the underlying principles of the invention are not limited to any particular programming language or architecture.

In one embodiment, each of the modules/applications 123-125, 310, 131 downloaded to the user's computer 120 are temporary copies which are removed once the document editing and/or application installation process is complete. In another embodiment, the modules are stored/cached on the user's computer for a specified period of time prior to being deleted. Thus, if the user attempts to edit another document within the specified time period, copies of the modules may be retrieved directly from local storage rather than being re-downloaded. In one embodiment, the application downloader 112 determines whether newer versions of the modules exist than those that are stored locally on the user's computer and, if so, automatically transmits the newer versions to replace any previously stored copies.

Although illustrated as a single remote computer 100 in FIG. 1, the remote computer may be implemented using multiple physical servers. For example, a separate physical server (or servers) may be used for the Web server 101 and for the document work flow software 110. In addition, a separate file server may be used to store the documents 102 operated on by the embodiments of the invention (as described above). It should be noted, however, that the underlying principles of the invention are not limited to any particular hardware or software configuration for the remote computer and user's computer 120.

While the foregoing has described what are considered to be the best mode and/or other preferred embodiments, it is understood that various modifications may be made therein and that the concepts disclosed herein may be implemented in various forms and embodiments, and that they may be applied in numerous applications, only some of which have been described herein.

At different times, all or portions of the executable code or database for any or all of these software elements may reside in physical media or be carried by electromagnetic media. The various data components as well as system files relating to the software also may reside in or be transported via a variety of different media. Physical media include the memory of a computer system, such as various semiconductor memories, tape drives, disc drives and the like of general-purpose computer systems. All or portions of the software may at times be communicated through the Internet or various other telecommunications networks. Such communications, for example, may be to load the software from another computer into the Web server or into another network element. Thus, other types of media that may bear the software elements includes optical, electrical and electromagnetic waves, such as used across physical interfaces between local devices, through wired and optical landline networks and over various air-links.

The term “computer-readable medium” as used herein refers to any medium that participates in providing instructions to a processor for execution. Such a medium may take many forms including, but not limited to, non-volatile media, volatile media, and transmission media. Non-volatile media include, for example, optical or magnetic disks, such as any of the storage devices in the system of FIGS. 1 and 3. Volatile media include dynamic memory, such as random access main memory. Transmission media include coaxial cables, copper wire, fiber optics, and also the wires that comprise a bus within a computer system. Transmission media can also take the form of electric or electromagnetic signals, or acoustic or light waves such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other medium from which a computer can read. Various forms of computer-readable media may be involved in carrying one or more sequences of one or more instructions to a processor for execution. Additionally, program code for implementing the described operations may be in the form of computer instructions in any form (e.g., source code, object code, interpreted code, etc) stored in or carried by any computer- or machine-readable medium.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method for editing documents over a Web session comprising:
establishing a Web session with a user computer;
receiving a user request to edit a document from the user computer, the document having a particular document type and stored on a remote computer;
automatically downloading a copy of the document and one or more modules to the user computer, the one or more modules executable on the user computer to perform the operations of:
invoking an application associated with the document type on the user computer, the application to provide an interface allowing the user to edit the document on the user computer;
monitoring the state of the document copy, the state including an indication as to whether the document copy has been modified by the user to create a modified document copy;
automatically uploading the modified document copy to the remote computer responsive from an indication that the document copy has been modified.

2. The method as in claim 1 further comprising:
determining whether the application associated with the document type is installed on the user computer; and
if the application associated with the document type is not installed on the user computer, then transmitting application program code to the user computer and installing the application program code on the user computer.

3. The method as in claim 2 further comprising:
determining if the user and/or the user computer should be permitted to install the application; and
transmitting and installing the application on the user computer only if the user should be permitted to install the application.

4. The method as in claim 1 wherein invoking comprises calling an executable file of the application.

5. The method as in claim 1 wherein monitoring comprises periodically comparing a characteristic of the document with the copy of the document.

6. The method as in claim 5 wherein the characteristic comprises a last modified date of the document and the copy of the document.

7. The method as in claim 1 further comprising:
initially receiving a hypertext transport protocol (“HTTP”) request from a Web browser installed on the user computer;
responsively generating a Web page containing a graphical representation of the document; and
transmitting the Web page with the graphical representation to the Web browser;
wherein, receiving the request from the user computer comprises receiving an HTTP request indicating that the user has selected the graphical indication.

8. The method as in claim 1 further comprising:
if network connectivity with the user computer is temporarily lost when the state of the document indicates that the document copy has been modified, then allowing the user to continues to modify the document; and
automatically uploading the modified document copy to the remote computer as soon as network connectivity with the user computer has been reestablished.

9. A system for editing documents over a Web session comprising:
a remote computer system including a Web server to receive a user request to edit a document from a user computer, the document having a particular document type, the remote computer system automatically downloading a copy of the document and one or more modules to the user computer, the one or more modules including:
an invoker module to invoke an application associated with the document type on the user computer, the application to provide an interface allowing the user to edit the document on the user computer;
a monitor module to monitor the state of the document copy, the state including an indication as to whether the document copy has been modified by the user to create a modified document copy;
an uploader module to upload the modified document copy to the remote computer responsive from an indication that the document copy has been modified.

10. The system as in claim 9 further comprising:
an application installer module to transmit application program code to the user computer if the application associated with the document type is not installed on the user computer, the application program code usable to install the application on the user computer.

11. The system as in claim 10 further comprising:
a user authentication module to determine if the user and/or the user computer should be permitted to install the application; wherein the application installer module transmits the application to the user computer only if the user should be permitted to install the application.

12. The system as in claim 9 wherein invoking comprises calling an executable file of the application.

13. The system as in claim 9 wherein monitoring comprises periodically comparing a characteristic of the document with the copy of the document.

14. The system as in claim 13 wherein the characteristic comprises a last modified date of the document and the copy of the document.

15. The system as in claim 9 wherein the Web server initially received a hypertext transport protocol (“HTTP”) request from a Web browser installed on the user computer and responsively generates a Web page containing a graphical representation of the document; the Web server further to transmit the Web page with the graphical representation to the Web browser of the user computer,
wherein, receiving the request from the user computer comprises receiving an HTTP request indicating that the user has selected the graphical indication.

16. The system as in claim 9 wherein if network connectivity with the user computer is temporarily lost when the state of the document indicates that the document copy has been modified, then the uploader module to automatically upload the modified document copy to the remote computer as soon as network connectivity with the user computer has been reestablished.

17. A machine-readable medium having program code stored thereon which, when executed by a machine, causes the machine to perform the operations of:
establishing a Web session with a user computer;
receiving a user request to edit a document from the user computer, the document having a particular document type;
automatically downloading a copy of the document and one or more modules to the user computer, the one or more modules to perform the operations of:
invoking an application associated with the document type on the user computer, the application to provide an interface allowing the user to edit the document on the user computer;
monitoring the state of the document copy, the state including an indication as to whether the document copy has been modified by the user to create a modified document copy;
automatically uploading the modified document copy to the remote computer responsive from an indication that the document copy has been modified.

18. The machine-readable medium as in claim 17 including additional program code to cause the machine to perform the operations of:
determining whether the application associated with the document type is installed on the user computer; and
if the application associated with the document type is not installed on the user computer, then transmitting application program code to the user computer and installing the application program code on the user computer.

19. The machine-readable medium as in claim 17 including additional program code to cause the machine to perform the operations of:
determining if the user and/or the user computer should be permitted to install the application; and
transmitting and installing the application on the user computer only if the user should be permitted to install the application.

20. The method as in claim 17 wherein invoking comprises calling an executable file of the application.
